(19) United States
(12) Patent Application Publication
(10) Pub. No.: US 2023/0305314 A1
(43) Pub. Date: Sep. 28, 2023

(54) EYEGLASSES WITH MAGNET DEPLOYMENT

(71) Applicant: JAMES COLOSIMO, SAINT CLAIR SHORES, MI (US)

(72) Inventor: JAMES COLOSIMO, SAINT CLAIR SHORES, MI (US)

(21) Appl. No.: 17/581,857

(22) Filed: Jan. 22, 2022

(51) Int. Cl. G02C 3/00; G02C 5/14

(52) U.S. Cl. CPC G02C 3/003; G02C 5/143; G02C 2200/02

(57) ABSTRACT

Eyeglasses including magnets deployed to the wearer’s ear providing slip-slide-droop restriction and ear ornamentation.

### BACKGROUND

Wearers’ complaints about their eyeglasses are well documented. U.S. Pat. 5,719,655 explains irritation at the ears and nose resulting from eyeglasses not maintaining a constant position. U.S. Pat. 4,389,102 uses cords to restrain eyeglass temples from sliding. U.S. Pat. 9,946,095 discusses damage to eyeglasses resulting from sporting activities. Sporting activities, hot weather and quick motions cause eyeglasses to slip, slide, droop or fall off. Discomfort and irritation inspired the author of U.S. Pat. 5,719,655 to eliminate eyeglass temples completely.

While many patents have documented the negative features of eyeglass temples, it is important to realize that temples also provide great convenience. Eyeglass wearers raise and lower eyeglasses to and from their face many times per day alternating between eyeglass types such as reading, computer, distance vision, sun and fashion. Eyeglass temples use the wearer’s ears as a convenient resting place while also allowing quick eyeglass removal. For these benefits, eyeglass temples should not be deleted.

When a person wears eyeglasses he may consciously or subconsciously feel the need to limit his physical activity and quickness of motion. The wearer has learned to not move so impulsively, and he is less prepared for athletics. Dare he play frisbee, play basketball with his kids, play soccer, or go for a boat ride? Does he put his eyeglasses in his pocket? Does he set them down somewhere? Will his eyeglasses fall, scratch, bend, break and otherwise become damaged or lost. This lack of confidence may cause him to become passive and less active. The eyeglasses feel like a handicap. No one wants their capabilities limited. But, that is what eyeglasses often do.

Eyeglasses, placed on your face in contact with your nose, head and ears, feel like a foreign object. Why is this acceptable? What if the eyeglasses felt as one with the body like a sneaker to your foot? Sneakers improve the tennis player’s performance versus volleying barefoot, while also providing comfort and protection from bloody skin damage. Similarly, full foot fins help the scuba diver versus diving barefoot. In both examples, the wearer enjoys the improved performance. The sneakers and full foot fins inspire confidence, improve performance, and feel like an extension of the body. Eyeglasses may improve vision performance, but the wearer too often feels physically handicapped and less agile.

Imagine the confidence the wearer would feel if he knew his eyeglasses would not shift, slip, slide, droop or fall off even when running, jumping or sweating. His eyeglasses would no longer feel like a handicap or a foreign object. The wearer’s confidence in the performance of his eyeglasses would grow. His eyeglasses would begin to feel like an extension of his body, helping him to achieve maximum results.

Another area of discomfort and displeasure relates to cartilage ear piercings. Cartilage ear ornamentation can be painful for the wearer. Cartilage ear piercings cause ongoing discomfort to many people who decide to endure the piercing procedure. Documented drawbacks of cartilage ear piercings include chronic pain and infection at and near the site of the piercings. Piercings provide ornamental benefits, but pain forces many people to grudgingly allow their piercings to close up. Are piercings really necessary, or can the ornamental benefits be attained another way?

What if the ongoing pain, inflammation and infection resulting from cartilage ear piercings could be avoided? Imagine if the wearer’s eyeglasses could provide not only slip, slide and droop restriction, but also ornamentation benefits similar to cartilage ear piercings!

### SUMMARY

Conventional eyeglasses include lenses, a frame, two temples and means for attaching all components into an assembly. This patent discloses and claims a novel invention for eyeglasses comprising a tunnel inside the eyeglass temple. The tunnel is used to deploy magnets to the ear and retract magnets away from the ear of the wearer. When deployed, the magnets form a magnetic bond at the wearer’s ear. With the wearer’s ear sandwiched in-between this magnetic bond, the motion of the eyeglass temple with respect to the wearer’s ear is restricted. The wearer’s eyeglasses remain in optimum position on his head during activities when conventional eyeglasses might slip, slide, droop or fall off. This allows the wearer to perform confidently during sporting activities, all the while knowing his eyeglasses will improve his performance like the sneakers on his feet. When physical activity is minimal, the wearer retracts the magnets away from his ear, breaking the magnetic bond, allowing simple eyeglass removal similar to the function of conventional eyeglass temples.

When the wearer deploys magnets to his ear to form a magnetic bond with his ear sandwiched in-between, this provides an opportunity for cartilage earring ornamentation. If the cartilage earring has composition including temporary magnet or permanent magnet material, the wearer only needs to position the cartilage earring near the front of his ear and release it. The cartilage earring then magnetically attracts toward and joins the magnetic bond already present at the wearer’s ear. With the cartilage earring magnetically bonded at the front of the wearer’s ear, ornamentation is achieved without the requirement for a painful cartilage ear piercing.

It is an object of the invention to provide eyeglasses that do not slip, slide, droop or fall from the wearer’s face.

It is a further object of the invention to provide eyeglasses that form a magnetic bond with the wearer’s ear sandwiched in-between.

It is a further object of the invention to provide eyeglasses that remain stably positioned on the face of the wearer during sporting activities.

It is a further object of the invention to provide eyeglasses that form a magnetic bond at the ear of the wearer only when activated by the wearer to do so.

It is a further object of the invention to provide eyeglasses that deploy magnets to the ear by pushing a control button on the eyeglass temple.

It is a further object of the invention to provide eyeglasses that retract magnets away from the ear with the push of a control button.

It is a further object of the invention to provide eyeglasses that reduce the forward and rearward motion of the temples relative to the position of the wearer’s ear.

It is a further object of the invention to inspire confidence by the wearer that his eyeglasses will maintain a secure fit like a sneaker to a foot.

It is a further object of the invention to provide eyeglasses that allow ear ornamentation similar to ornamentation achieved by cartilage ear piercings.

It is a further object of the invention to provide eyeglasses with a back-of-ear magnet magnetically bonding to a front-of-ear cartilage earring to provide both ornamentation and slip-slide-droop restriction.

It is a further object of the present invention to provide eyeglasses that do not feel like a handicap or a foreign object on the face of the wearer, but instead inspire confidence to the wearer by remaining in optimum position on the wearer’s head during physical activities that may include running, jumping and perspiring.

It is a further object of the present invention to provide eyeglasses with a back-of-ear (BOE) line and a back-of-ear (BOE) magnet that are removably secured to the eyeglass temple.

### BRIEF DESCRIPTION OF THE DRAWINGS

FIG. 1 shows a side view of SSDR eyeglasses in retraction mode with the BOE magnet at 91 to Datum A and the FOE magnet bonded to a steel plate.

FIG. 2 shows a side view of SSDR eyeglasses in deployment mode with the BOE magnet magnetically bonded to the FOE magnet and the wearer’s ear sandwiched in-between.

FIG. 3 shows a front perspective view of SSDR eyeglasses in retraction mode.

FIG. 4 shows a front perspective view of SSDR eyeglasses in deployment mode.

FIG. 5 shows a plan view of SSDR eyeglasses in deployment mode.

FIG. 6 shows a rear view of SSDR eyeglasses in deployment mode.

FIG. 7 shows an exploded rear perspective view of the SSDR temple assembly with the control button in retraction mode. A cross-section at 80 mm to Datum A shows the BOE line and FOE line inside the tunnel.

FIG. 8 shows an exploded rear perspective view of SSDR temple assembly including a cross-section at 40 mm to Datum A with the control button in retraction mode attached to the BOE line and FOE line.

FIG. 9 shows an exploded side view of the SSDR temple assembly in retraction mode.

FIG. 10 shows an exploded rear perspective view of SSDR temple assembly including a cross-section at 95 mm to Datum A with the control button in deployment mode. The BOE line exits through the BOE slot. The BOE magnet is positioned at the back of the wearer’s ear. The FOE line is inside the tunnel.

FIG. 11 shows an exploded rear perspective view of SSDR temple assembly including a cross-section at 112 to Datum A with the control button in deployment mode. The FOE magnet is magnetically bonded to the BOE magnet with the wearer’s ear sandwiched in-between.

FIG. 12 shows a front perspective view of SSDR eyeglasses in deployment mode with a cartilage earring magnetically bonded to the FOE magnet.

FIG. 13 is the similar to FIG. 11 with the addition of an ornamental cartilage earring magnetically bonded to the FOE magnet.

FIG. 14 shows a side view of SSDRNR eyeglasses with the forward end of a BOE line removably secured to a SSDRNR temple assembly at 85 to Datum A.

FIG. 15 is a side view of SSDRNR eyeglasses showing a BOE magnet magnetically bonded to a cartilage earring with the wearer’s ear sandwiched in-between.

FIG. 16 is an exploded rear perspective view of a SSDRNR temple assembly showing a BOE magnet magnetically bonded to a cartilage earring with the wearer’s ear sandwiched in-between.

### DETAILED DESCRIPTION

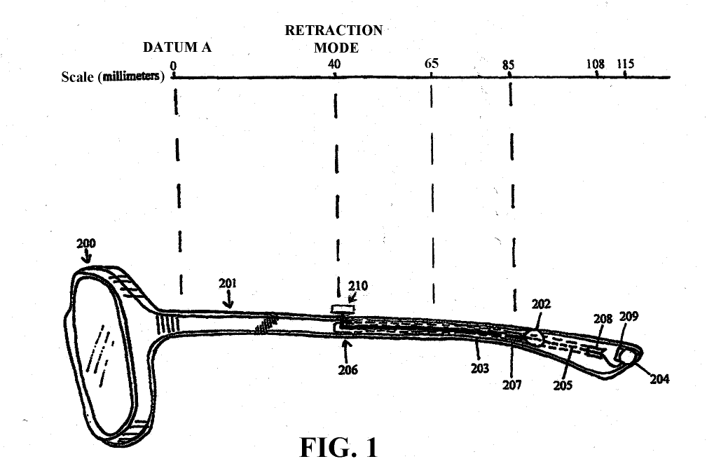

In the first embodiment, FIG. 1 shows slip-slide-droop resistant (SSDR) eyeglasses 200, including SSDR temple assembly 201. The forward end of SSDR temple assembly 201 attaches to SSDR eyeglasses 200 at location 0 mm. The location 0 mm is defined as Datum A on the scale (millimeters). All components of SSDR temple assembly 201 are dimensioned rearward from Datum A. Internal to SSDR temple assembly 201 is tunnel 206, a cylindrical cavity starting 40 mm from Datum A. Said tunnel 206 has 2.9 mm diameter and 69 mm length, ending 109 mm from Datum A. Tunnel 206 serves as a pathway for two lines to traverse. Back-of-ear (BOE) line 203, with 2.4 mm diameter and 51 mm length, traverses through tunnel 206. Front-of-ear (FOE) line 205, with 0.28 mm diameter and 80 mm length, also traverses through said tunnel 206. Control button 210 is located 40 mm from Datum A, and this condition is defined as retraction mode. When in retraction mode, SSDR eyeglasses 200 function similar to eyeglasses with conventional temples, providing the important feature of quick and easy removal often needed in a home or office setting when it is necessary to switch back and forth between distance, reading, computer or other types of eyeglasses.

Continuing to reference FIG. 1, control button 210 extends downward into tunnel 206 and attaches to the forward ends of BOE line 203 and FOE line 205. BOE line 203 routes inside tunnel 206 and exits said tunnel 206 through BOE slot 207. BOE slot 207 is a rectangular hole located at the side of SSDR temple assembly 201 centered 85 mm from Datum A. BOE slot 207 has dimensions 2.7 mm height and 4 mm length, beginning 83 mm and ending 87 mm from Datum A. BOE line 203 attaches near its rearward end to back-of-ear (BOE) magnet 202. Said BOE magnet 202 is a neodymium permanent magnet with dimensions 4 mm diameter and 3 mm thickness. With eyeglasses 200 in retraction mode, said control button 210 is located 40 mm from Datum A and said BOE magnet 202 is positioned 91 mm from Datum A, adjacent to BOE slot 207.

As shown in FIG. 1, FOE line 205 routes inside tunnel 206 and exits said tunnel 206 through FOE slot 208. FOE line 205 is fishing line with diameter similar to a human hair. FOE slot 208 is a rectangular hole in the side of SSDR temple assembly 201 centered 108 mm from Datum A. FOE slot 208 has dimensions 1 mm height and 2 mm length, beginning 107 mm and ending 109 mm from Datum A. Front-of-ear (FOE) magnet 204 attaches to the rearward end of said FOE line 205. Said FOE magnet 204 is a neodymium permanent magnet with dimensions 4 mm diameter and 3 mm thickness. Said FOE magnet 204 magnetically bonds to steel plate 209. Said steel plate 209 has 3 mm height, 4 mm length and is centered 115 mm from Datum A.

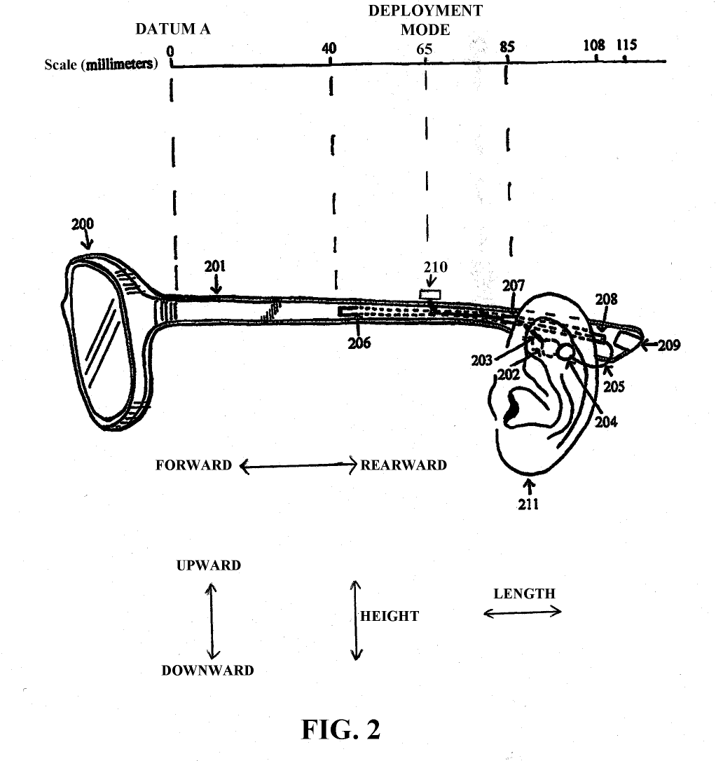

FIG. 2 shows SSDR eyeglasses 200 in wearing position on the head of the wearer. References to “Wearer” indicates a person with his eyeglasses in normal wearing position, with the wearer’s eyes looking out through the lenses and SSDR temple assembly 201 resting on the wearer’s ear 211. FIG. 2 shows SSDR temple assembly 201 in deployment mode. When in deployment mode, control button 210 is located at 65 mm to Datum A. The wearer has pushed rearward on control button 210, moving said control button 210 from retraction mode 40 mm from Datum A to its deployment mode location 65 mm from Datum A. The wearer uses control button 210 for controlling the position of the forward ends of BOE line 203 and FOE line 205 inside tunnel 206. Moving said control button 210 from retraction mode to deployment mode causes BOE line 203 to extend 25 mm rearward on an arc, deploying BOE magnet 202 into soft contact with the back of the wearer’s left ear 211. BOE line 203 is composed of trimmer line that can be purchased at a hardware store. Said BOE line 203 is stiff and rigid, and is purchased in wrapped circular coil packaging. This packaging preforms BOE line 203 into an arc shape, a convenient benefit for this application. Moving control button 210 from retraction mode to deployment mode also causes FOE line 205 to traverse 25 mm rearward, deploying 25 mm of said FOE line 205 toward steel plate 209. Putting to use this 25 mm of extra slack, the wearer uses his fingers to lift FOE magnet 204 away from steel plate 209. The wearer hovers said FOE magnet 204 at a distance of 10 mm forward of his ear 211. The wearer then releases said FOE magnet 204 from his grasp. Upon release, FOE magnet 204 magnetically attracts toward BOE magnet 202. Magnetic forces create a magnetic bond between said FOE magnet 204 and said BOE magnet 202 with said ear 211 sandwiched in-between said magnetic bond. With control button 210 fixed at 65 to Datum A, said magnetic bond fixes the locations of BOE line 203, BOE magnet 202, FOE magnet 204 and ear 211 in relation to each other. Slip-slide-droop restriction is achieved, restricting relative movement between said ear 211 and said SSDR temple assembly 201.

It’s a hot, sweaty summer day, but the wearer’s SSDR eyeglasses 200 do not slip, slide or droop down his nose. The wearer joins a soccer game and focuses on his soccer skills without concern his SSDR eyeglasses 200 might fly off his head due to his rapid movements. Observers of the soccer game do not visually notice the thin 0.28 mm diameter FOE line 205 at the front of his ear 211. Observers also may not visually detect FOE magnet 204 at the front of ear 211, since said FOE magnet 204 is color-matched to the skin color of said ear 211. Observers might wonder how it is possible his SSDR eyeglasses 200 remain optimally positioned, unaware that SSDR temple assembly 201 is slip-slide-droop restricted.

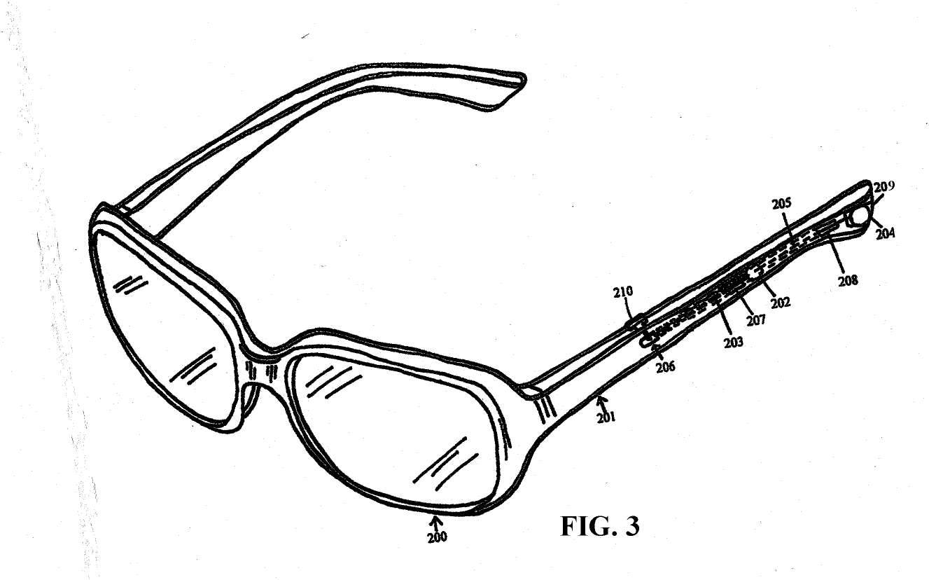

FIG. 3 shows a perspective view of SSDR eyeglasses 200 including SSDR temple assembly 201 for the left temple and a conventional right temple with no slip-slide-droop restriction. Said SSDR eyeglasses 200 are seen in retraction mode with control button 210 at 40 mm from Datum A. BOE magnet 202 is at 91 mm to Datum A and FOE magnet 204 is attached to steel plate 209.

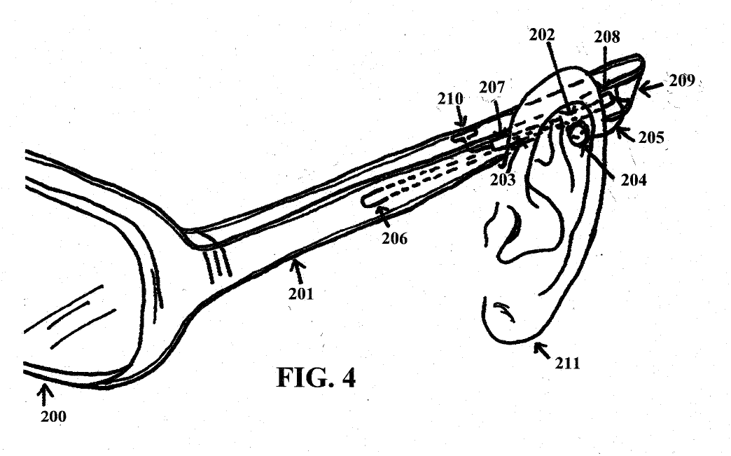

FIG. 4 shows SSDR eyeglasses 200 with SSDR temple assembly 201 in deployment mode. Control button 210 has transitioned to 65 mm from Datum A. BOE magnet 202 is deployed at the back of ear 211. The wearer has used his fingers to relocate FOE magnet 204 from its prior location bonded to steel plate 209 to the front of ear 211. BOE magnet 202 and FOE magnet 204 are magnetically bonded with ear 211 sandwiched in-between. The forward end of BOE line 203 is locked at 65 mm to Datum A, and as a result said SSDR temple assembly 201 provides slip-slide-droop restriction with respect to ear 211 even when the wearer runs, jumps, perspires, and performs a multitude of physical activities.

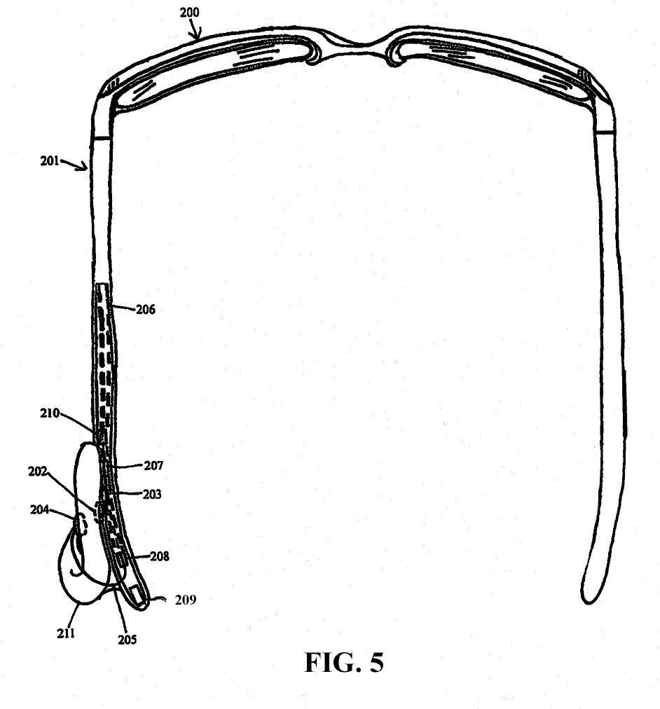

FIG. 5 shows a plan view of SSDR eyeglasses 200 in deployment mode. FOE magnet 204 is magnetically bonded to BOE magnet 202 with ear 211 sandwiched in-between, and FOE line 205 is shown attached to FOE magnet 204.

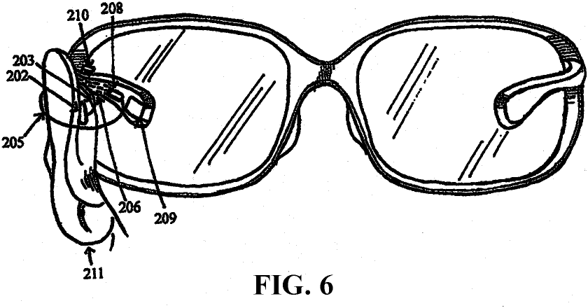

FIG. 6 shows a rear view of SSDR eyeglasses 200 in deployment mode. FOE line 205 exits FOE slot 208 and wraps around to the front of ear 211. BOE magnet 202 is positioned at the back of ear 211 near the rearward end of arcing BOE line 203.

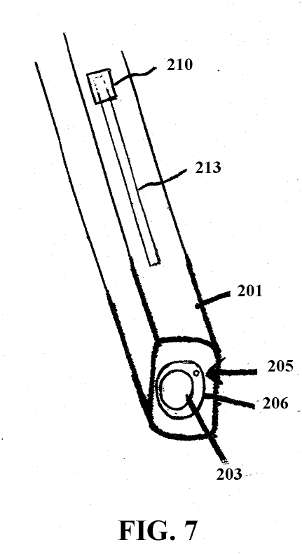

FIG. 7 shows an expanded perspective view of SSDR temple assembly 201 in retraction mode with a cross-section at 80 mm from Datum A. Said cross-section shows BOE line 203 and FOE line 205 inside tunnel 206. BOE line 203 is thick and rigid while FOE line 205 is thin similar to a human hair. Although thin, said FOE line 205 is strong and able to withstand many pounds of force. Control button 210 is shown in retraction mode 40 mm from Datum A. Button slit 213 provides a pathway for control button 210 to enter into tunnel 206. Said button slit 213 also provides a pathway for said control button 210 to transition between deployment mode and retraction mode. Said button slit 213 is a narrow slice at the top center of SSDR temple assembly 201 downward into tunnel 206. Said control button 210 extends through said button slit 213 and attaches to the forward ends of BOE line 203 and FOE line 205. Said button slit 213 starts 40 mm from Datum A and ends 65 mm from Datum A.

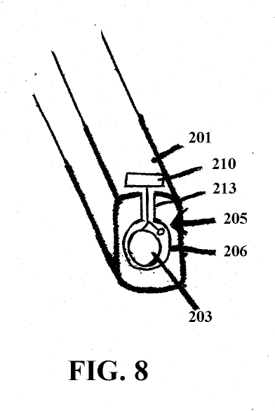

FIG. 8 shows an expanded perspective view of SSDR temple assembly 201 in retraction mode with cross-section at 40 mm to Datum A. Control button 210 extends through button slit 213 into tunnel 206. Inside said tunnel 206, said control button 210 attaches to the forward ends of BOE line 203 and FOE line 205.

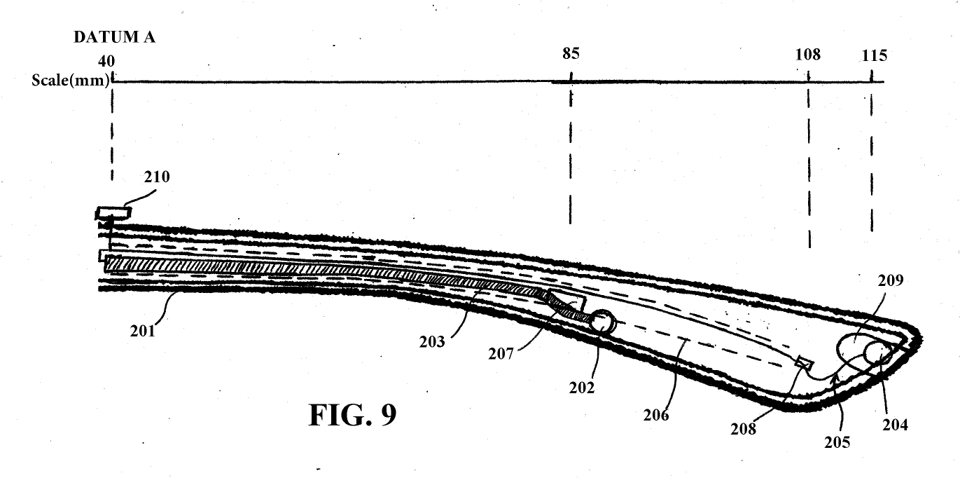

FIG. 9 shows an expanded side view of SSDR temple assembly 201 in retraction mode with control button 210 located 40 mm from Datum A. BOE line 203 and FOE line 205 attach to control button 210 inside tunnel 206. BOE magnet 202 is attached near the rearward end of BOE line 203. FOE magnet 204 is attached to the rearward end of FOE line 205. FOE magnet 204 is magnetically bonded to steel plate 209.

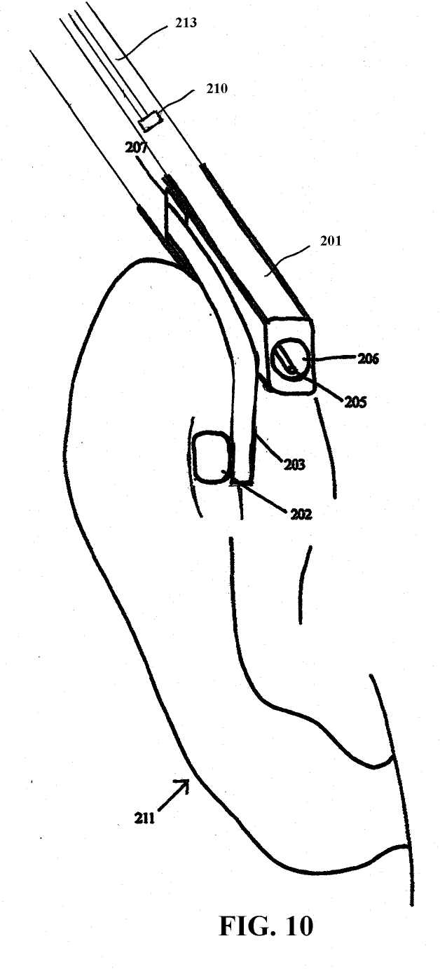

FIG. 10 is an expanded rear perspective view of SSDR temple assembly 201 in deployment mode showing BOE line 203 exiting tunnel 206 through BOE slot 207 on an arc to the back of ear 211. BOE magnet 202, attached near the rearward end of said BOE line 203, softly contacts the back of the wearer’s ear 211. A cross-section of SSDR temple assembly 201 is taken 95 mm from Datum A, showing FOE line 205 still inside tunnel 206.

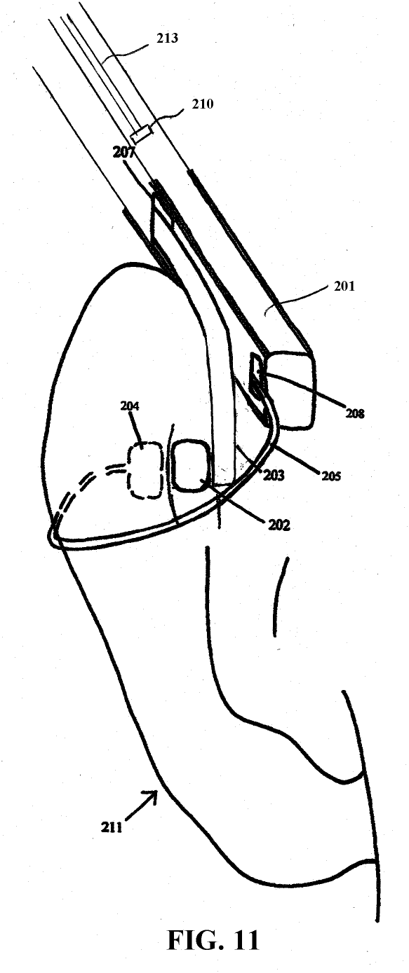

FIG. 11 shows a cross-section of SSDR temple assembly 201 at 112 mm from Datum A. Control button 210 is in deployment mode, causing the length of FOE line 205 outside FOE slot 208 to increase by 25 mm versus retraction mode. The wearer has released FOE magnet 204 at the front of ear 211.

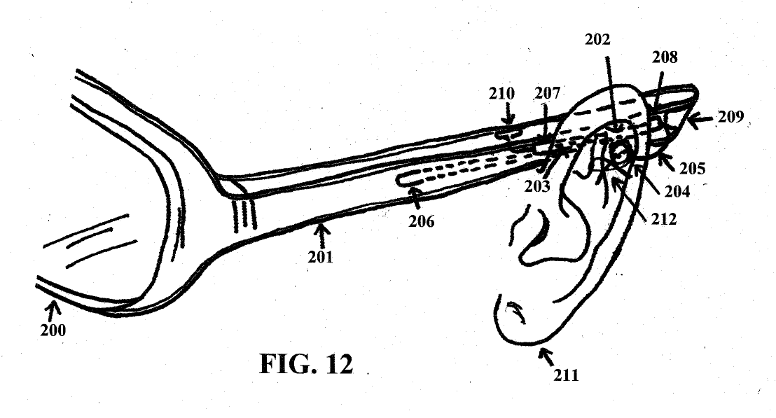

FIG. 12 is the same as FIG. 4 but with the addition of cartilage earring 212. Said cartilage earring 212 is an ornament with composition including magnetic material. The wearer has released said cartilage earring 212 10 mm forward of FOE magnet 204. Said cartilage earring 212 attracts toward and magnetically bonds to said FOE magnet 204. Ear ornamentation is thereby achieved by the wearer with no requirement for a cartilage ear piercing.

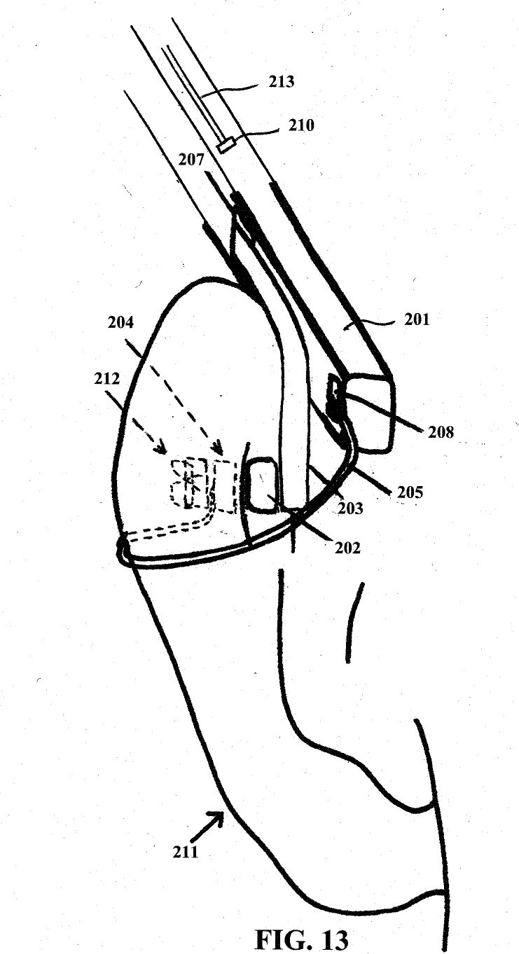

FIG. 13 is an expanded view showing the addition of cartilage earring 212. Said cartilage earring 212 is magnetically bonded to FOE magnet 204, providing ornamentation similar to a pierced cartilage earring. The wearer enjoys the ornamental benefit without the pain associated with the piercing experience.

The wearer wakes in the morning and raises SSDR eyeglasses 200 in retraction mode to his head with SSDR temple assembly 201 resting on his left ear 211. As the wearer prepares for a jog, he pushes control button 210 rearward 25 mm into deployment mode, causing BOE magnet 202 to deploy to the back of ear 211. The wearer grasps FOE magnet 204 in his fingers and releases it near the front of said ear 211. FOE magnet 204 magnetically bonds to BOE magnet 202 with ear 211 sandwiched in-between. The wearer is now ready to jog with full confidence his SSDR eyeglasses 200 will not slip, slide or droop. Conventional eyeglasses commonly would slide during his jog due to perspiration or a quick change of direction, but SSDR eyeglasses 200 remain optimally positioned. During his jog an accident occurs. A small low hanging tree branch contacts his SSDR eyeglasses 200, knocking them off his head. The impact force from contact with the branch was enough to overcome the magnetic bond at ear 211, sending SSDR eyeglasses 200 to the ground. Important for physical safety, the magnetic bond between BOE magnet 202 and FOE magnet 204 breaks from a strong external force, protecting the wearer’s ear 211 from damage. The wearer simply retrieves and replaces SSDR eyeglasses 200 on his face in deployment mode and continues his jog. Upon returning home, the wearer pushes button 210 from deployment mode to retraction mode, causing BOE magnet 202 to retract to 91 mm from Datum A, and also causing FOE magnet 204 to retract toward and magnetically bond to steel plate 209.

An hour later, the wearer enters his work office with SSDR eyeglasses 200 in retraction mode. He removes SSDR eyeglasses 200 and puts his computer eyeglasses on. Then, to read documents, he changes to reading eyeglasses. Then he switches to SSDR eyeglasses 200 in retraction mode for a meeting with co-workers where distance vision is needed. The wearer easily switches back and forth as necessary, with SSDR eyeglasses 200 functioning in retraction mode as ordinary conventional eyeglasses.

Upon arriving home in the evening summer heat, his wife suggests a bike ride. The kids want to play basketball and catch, and his Labrador retriever wants him to throw the tennis ball. The wearer pushes control button 210 rearward 25 mm into deployment mode. Instead of positioning FOE magnet 204 at the front of his ear 211, this time the wearer allows FOE magnet 204 to remain bonded to steel plate 209. The wearer instead grasps cartilage earring 212 from his pocket and releases said cartilage earring 212 approximately 10 mm forward of ear 211. Cartilage earring 212 attracts toward BOE magnet 202 and magnetically bonds to said BOE magnet 202 with ear 211 sandwiched in-between. Cartilage earring 212 performs the same function as FOE magnet 204. The wearer enjoys the slip-slide-droop restricting benefits of his SSDR temple assembly 201 while also enjoying the ornamental benefit of the cartilage earring 212. Life is great for the wearer as all his activities are achieved easily and confidently with his SSDR eyeglasses 200 in deployment mode. What a great day!

If the wearer didn’t have cartilage earring 212 in his pocket, he simply would have used FOE magnet 204 as he had done for his morning jog. If the wearer later found cartilage earring 212, the wearer could have released it forward of FOE magnet 204 to form a three magnet bond including BOE magnet 202, ear 211, FOE magnet 204 and cartilage earring 212. If the wearer prefers to exclusively use cartilage earring 212 instead of FOE magnet 204, then several items may be deleted from SSDR temple assembly 201.

Deleted items could include FOE magnet 204, FOE line 205, FOE slot 208 and steel plate 209.

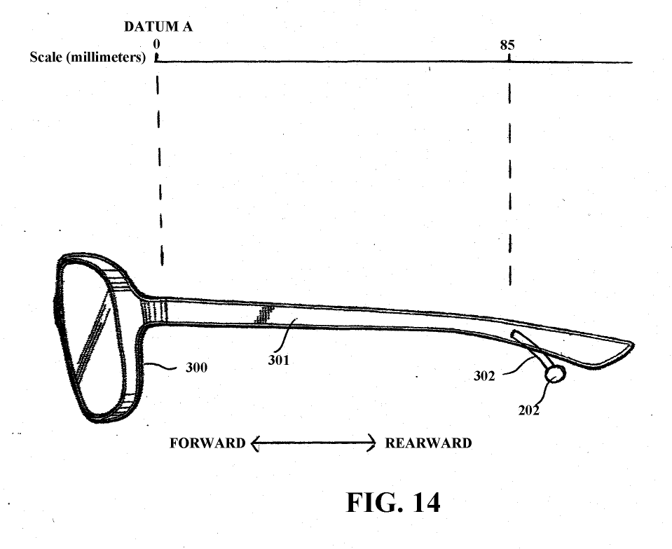

A second embodiment is shown in FIG. 14. For this embodiment, there is no retraction mode. FIG. 14 shows a side view of slip-slide-droop restricting non-retractable (SSDRNR) eyeglasses 300 including temple 301. BOE line 302 is removably secured at its forward end to temple 301 at location 85 mm to Datum A. BOE magnet 202 is attached near the rearward end of said BOE line 302. BOE line 302 is identical to BOE line 203 except overall length is reduced from 51 mm to 31 mm.

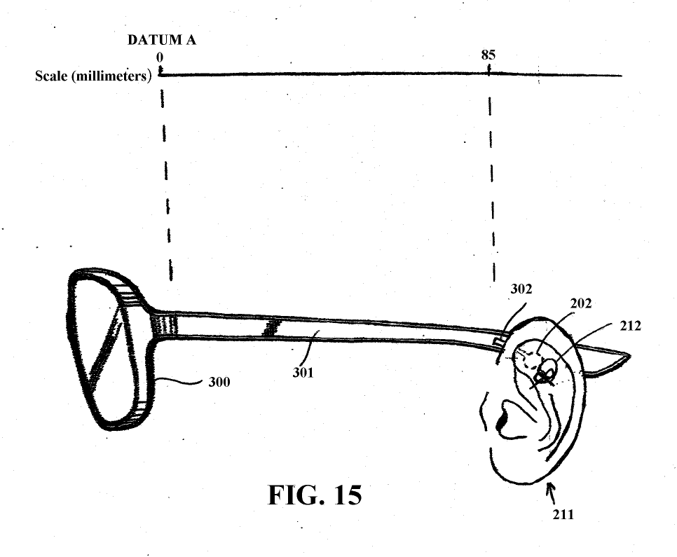

FIG. 15 shows a side view of SSDRNR eyeglasses 300 with the forward end of BOE line 302 secured to temple 301. BOE line 302 extends on an arc to the back of the wearer’s ear 211. Said BOE magnet 202 is attached near the rearward end of said BOE line 302. The wearer grasps cartilage earring 212 from his pocket and releases it approximately 10 mm forward of ear 211. Magnetic attraction pulls said cartilage earring 212 toward said BOE magnet 202. Said cartilage earring 212 magnetically bonds to said BOE magnet 202 with said ear 211 sandwiched in-between said magnetic bond.

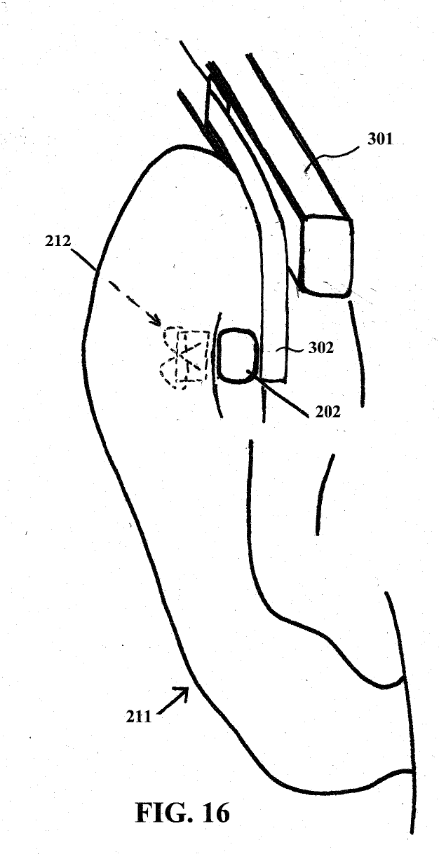

FIG. 16 is an expanded rear perspective view of temple 301 showing cartilage earring 212 magnetically bonded to BOE magnet 202 with ear 211 sandwiched in-between said magnetic bond. In addition to slip-slide-droop restriction, the wearer enjoys ornamental benefits similar to those gained from painful cartilage piercings. If said cartilage earring 212 is not available to the wearer, BOE line 302 and BOE magnet 202 dangle harmlessly at the back of the wearer’s ear 211. Optionally, the wearer may unsecure and remove said BOE line 302 from SSDRNR eyeglasses 300.

FOE and BOE magnets may be of various sizes and shapes and may be shaded to match the wearer’s skin color. The composition of the BOE magnet 202, FOE magnet 204 and cartilage earring 212 typically includes neodymium permanent magnet material. It is possible for temporary magnet material to replace some permanent magnet material. The composition of said steel plate 209 could include permanent magnet material, thereby allowing temporary magnet composition for FOE magnet 204. Control button transition between deployment mode and retraction mode could be aided by a motor. Other materials can be used in place of fishing line and trimmer line. Back-of-ear and front-of-ear lines may exit from the temple assembly at various locations. Larger magnets may be used for increased bonding strength. Neodymium magnets are used due to their higher magnetic strength, but other permanent magnet compositions are possible. It is only necessary for eyeglasses to have one SSDR temple assembly. If the left temple is a SSDR temple assembly, the right temple can be a conventional temple. With one temple assembly restricting temple motion with respect to the ear, overall eyeglass motion is restricted. A miniature tape-measure-type retraction device could be added near the rearward end of the temple assembly to deploy and retract the FOE line. Multiple BOE magnets may be deployed to the wearer’s ear, allowing multiple cartilage earring attachments. Various attachment means known in the art may be used including adhesives, insert-molding and welding technologies. Attachments can be permanent or temporary and removable. These and additional modifications may be made without departing from the scope of the inventive concepts described herein.

1. Eyeglasses comprising at least one temple assembly:
a. Said temple assembly comprising a tunnel;
b. Said temple assembly further comprising a back-of-ear (BOE) line traversing through said tunnel;
c. Said temple assembly further comprising a control button controlling the position of said BOE line inside said tunnel;
d. Said temple assembly further comprising a BOE slot through which said BOE line exits said tunnel;
e. Said temple assembly further comprising a BOE magnet attached to said BOE line;
f. Said temple assembly further comprising a button slit;
g. Wherein said control button extends through said button slit into said tunnel;
h. Wherein said control button attaches to said BOE line.

2. Eyeglasses as in claim 1,
a. Wherein said BOE line traverses forward into retraction mode and rearward into deployment mode through said tunnel;
b. Wherein said BOE line traverses between retraction mode and deployment mode at the push of said control button by said wearer;
c. Wherein the rearward end of said BOE line exits said tunnel through said BOE slot;
d. Wherein said forward end of said BOE line attaches to said control button inside said tunnel;
e. Wherein said BOE magnet is attached near the rearward end of said BOE line;
f. Wherein said BOE magnet deploys to the back of the wearer’s ear when said control button is in deployment mode;
g. Wherein said BOE magnet is retracted away from the back of the wearer’s ear when in retraction mode.

3. Eyeglasses as in claim 2,
a. Further comprising a cartilage earring;
b. Wherein said cartilage earring has composition including magnetic material;
c. Wherein said cartilage earring magnetically bonds to said BOE magnet in deployment mode;
d. Wherein said wearer’s ear is sandwiched in-between said magnetic bond;
e. Wherein said magnetic bond restricts relative movement between said wearer’s ear and said temple assembly;
f. Wherein said cartilage earring provides ear ornamentation.

4. Eyeglasses as in claim 2,
a. Further comprising a front-of-ear (FOE) line traversing through said tunnel;
b. Further comprising a FOE magnet attached to the rearward end of said FOE line;
c. Further comprising a FOE slot through which said FOE line exits said tunnel;
d. Further comprising a steel plate;
e. Wherein said FOE line traverses between retraction mode and deployment mode at the push of said control button by said wearer;
f. Wherein the forward end of said FOE line attaches to said control button inside said tunnel;
g. Wherein said control button controls the position of said FOE line inside said tunnel.

5. Eyeglasses as in claim 4,
a. Wherein said FOE magnet magnetically bonds to said steel plate in retraction mode;
b. Wherein said FOE magnet magnetically bonds to said BOE magnet when in deployment mode;
c. Wherein said wearer’s ear is sandwiched in-between said magnetic bond between said BOE magnet and said FOE magnet;
d. Wherein said magnetic bond between said BOE magnet and FOE magnet restricts relative movement between said wearer’s ear and said temple assembly.

6. Eyeglasses as in claim 5,
a. Further comprising a cartilage earring;
b. Wherein said cartilage earring has composition including magnetic material;
c. Wherein said cartilage earring magnetically bonds to said FOE magnet in deployment mode;
d. Wherein said cartilage earring provides ear ornamentation.

7. Eyeglasses comprising:
a. A temple;
b. A back-of-ear (BOE) line secured to said temple;
c. A back-of-ear (BOE) magnet attached to said BOE line.

8. Eyeglasses as in claim 7,
a. Wherein the forward end of said BOE line is secured to said temple;
b. Wherein said BOE magnet attaches near the rearward end of said BOE line;
c. Wherein said BOE magnet is positioned at the back of the wearer’s ear.

9. Eyeglasses as in claim 8,
a. Further comprising a cartilage earring;
b. wherein said cartilage earring includes magnetic material composition;
c. Wherein said cartilage earring magnetically bonds to said BOE magnet with said wearer’s ear sandwiched in-between said magnetic bond;
d. Wherein said magnetic bond restricts relative movement between said wearer’s ear and said temple assembly;
e. Wherein said cartilage earring provides ear ornamentation.

10. Eyeglasses as in claim 9,
a. Wherein the forward end of said BOE line is removably secured to said temple.

11. Eyeglasses as in claim 9,
a. Wherein the forward end of said BOE line is permanently secured to said temple.
